(19) United States
(12) Patent Application Publication
(10) Pub. No.: US 2026/0159340 A1
(43) Pub. Date: Jun. 11, 2026

(54) Trailer Restraints, Systems, and Methods Associated Therewith

(71) Applicant: THE CHAMBERLAIN GROUP LLC, OAK BROOK, IL (US)

(72) Inventors: Timothy Muhl, Slinger, WI (US); Brett Lindstrom, Cedarburg, WI (US); Jeff Schulze, Hortonville, WI (US)

(21) Appl. No.: 19/364,466

(22) Filed: Oct. 21, 2025

Related U.S. Application Data
(60) Provisional application No. 63/710,348, filed on Oct. 22, 2024.

(51) Int. Cl. B65G 69/00

(52) U.S. Cl. CPC B65G 69/003

(57) ABSTRACT

A trailer restraint configured to secure a trailer at a relatively fixed location with respect to a facility, the trailer restraint including a body configured to be anchored to a structure at the facility; a linear actuator rotatably coupled to the body about a pivot point and reconfigurable between a stored position and a trailer engagement position; and a trailer hook translatably driven by the linear actuator between a first position and a second position, wherein the linear actuator is rotatable about the pivot point when the trailer hook is in the first position, and wherein the trailer hook is configured to apply a restraining force to the trailer bar when the trailer hook is in the second position.

### CROSS-REFERENCE TO RELATED APPLICATIONS

The present application claims priority to U.S. Provisional Patent Application Serial No. 63/710,348, filed on October 22, 2024, the disclosure of which is incorporated by reference herein in its entirety.

### FIELD

The present disclosure relates generally to trailer restraints and methods associated therewith. More particularly, the present disclosure relates to trailer and/or vehicle restraints that restrain movement of said trailers and/or vehicles at facilities, such as loading docks and warehouses, to mitigate movement of the trailer and increase safety for facility workers and equipment.

### BACKGROUND

Shipping goods from a point of origination to a final destination is typically performed using various modes of transportation, such as ships, planes, trucks, and trains. At various stages of shipment, goods arrive at a shipping node, such as a seaport, an airfield, a warehouse, a train yard, a retail location, a manufacturing facility, or the like, where the goods are unloaded from a previous vessel and loaded onto a new vessel or consumed or sold. For example, intercontinental shipments typically arrive at a seaport or airfield where the goods are offloaded from the carrying ship or plane. The goods are then loaded onto other vessels, such as trucks or trains which take the goods to their next shipping node for further handling. This process repeats until the goods arrive at their final destination.

During the shipping process, it is not uncommon for goods to pass through many shipping nodes, each time requiring unloading from the existing vessel and loading onto a new vessel. Each loading and unloading operation requires workers to enter the vessel to handle the goods. For example, ground-based shipping facilities in the form of warehouses typically include loading docks to which trailers are backed up against. Workers move from the warehouse floor into the trailer to grab the goods and then move out of the trailer onto the warehouse floor carrying the goods from the trailer to the warehouse. This process is repeated until the trailer is unloaded (fully or partially).

After being unloaded, the goods are routed through the warehouse based on shipping manifests and loaded into different trailers for further transit to the next shipping node, or are consumed, e.g., during manufacturing, or sold to end users.

In many instances, loading and unloading may be assisted by equipment, such as forklifts. This equipment is heavy and, when moving fully loaded pallets, can easily exceed three tons (6,000 pounds) or more. Additionally, visibility from the equipment may be limited (particularly when moving fully loaded pallets), preventing the equipment operator from fully inspecting the upcoming surface topography and conditions of the warehouse and trailer. As a result, the operator must rely on the safety protocols implemented by the warehouse and loading dock operator to avoid dangerous situations.

One example of a dangerous situation is in the case where a trailer is not properly restrained at the loading dock. Traditionally, trailer restraining was performed by positioning one or more wheel chocks in front of one or more of the trailer wheels to prevent the trailer from rolling away from the loading dock. However, it is not uncommon for a facility worker to forget to place wheel chocks in front of the wheels prior to entering the trailer or place the wheel chocks improperly. As a result, the force created by heavy equipment entering the trailer can cause the trailer to move away from the loading dock.

Despite the perceived advantages of using a negatively sloped ramp to mitigate trailer movement, i.e., a ramp that slopes towards the facility to direct the vehicle forces towards the facility, the constant entry of heavy equipment into the trailer can nevertheless cause the trailer to move up the ramp, creating a gap between the open end of the trailer and the loading dock. If the gap becomes large enough, it is possible that the equipment (with the worker onboard) can fall from the elevated height of the trailer and loading dock. This frequently results in worker injury or even death.

Accordingly, improved trailer restraints are desired in the art. In particular, trailer restraints which provide easy engagement with trailers and provide low-profile solutions that do not project away from facility walls would be advantageous. For example, it is not uncommon for facilities in cold climates to require snowplows or other equipment to pass closely by the facility, e.g., to clear snow and allow trailer access to the loading docks. A low-profile trailer restraint allows the snowplow or other equipment to closely pass by the loading dock (e.g., within 6-12 inches of the loading dock) without requiring workers to manually dig out snow compacted around a bulky trailer restraints.

### BRIEF DESCRIPTION

Aspects and advantages of the invention in accordance with the present disclosure will be set forth in part in the following description, or may be obvious from the description, or may be learned through practice of the technology.

In accordance with one embodiment, a trailer restraint is provided. The trailer restraint is configured to retain a trailer at a relatively fixed location with respect to a facility. The trailer restraint includes a body configured to be anchored to a structure at the facility; a linear actuator rotatably coupled to the body about a pivot point and reconfigurable between a stored position and a trailer engagement position; and a trailer hook translatably driven by the linear actuator between a first position and a second position, wherein the linear actuator is rotatable about the pivot point when the trailer hook is in the first position, and wherein the trailer hook is configured to apply a restraining force to a trailer bar when the trailer hook is in the second position.

In accordance with another embodiment, a method of restraining a trailer at a facility is provided. The method includes reconfiguring a linear actuator of a trailer restraint from a stored position to a trailer engagement position by rotating the linear actuator about a pivot point in an outward direction; with the linear actuator in the engagement position or rotating toward the engagement position, actuating the linear actuator to translate a trailer hook of the trailer restraint in a first direction to apply a compressive force to a trailer bar; and terminating actuation of the linear actuator upon reaching a prescribed condition.

In accordance with another embodiment, a trailer restraint configured to retain a trailer at a relatively fixed location with respect to a facility is provided. The trailer restraint includes a trailer hook coupled to a linear actuator, the trailer hook movable between a stored position and a trailer clamping position whereby the trailer hook applies compressive force to a trailer bar, and wherein movement from the stored position to the trailer clamping position comprises rotation of the linear actuator about a pivot axis and translation of the trailer hook towards the pivot axis.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 depicts a facility at which a vehicle towing a trailer containing freight arrives for loading/unloading in accordance with embodiments of the present disclosure;

FIG. 2 depicts a loading dock at the facility where the trailer is loaded/unloaded in accordance with embodiments of the present disclosure;

FIG. 3 depicts a vehicle restraint disposed at the loading dock of the facility for restraining movement of the vehicle, or a portion thereof, in accordance with embodiments of the present disclosure as seen in a stored position;

FIG. 4 depicts the vehicle restraint in accordance with embodiments of the present disclosure as seen with the vehicle restraint in a trailer clamping position engaged with a trailer bar of a trailer to retain the trailer at the loading dock;

FIG. 5 is a schematic of the vehicle restraint in accordance with embodiments of the present disclosure;

FIG. 6A is a cross-sectional side view of the vehicle restraint in accordance with embodiments of the present disclosure as seen with the vehicle restraint in the stored position;

FIG. 6B is a cross-sectional side view of the vehicle restraint in accordance with embodiments of the present disclosure as seen with the vehicle restraint in a reconfiguration process between the stored position and the trailer clamping position;

FIG. 6C is a cross-sectional side view of the vehicle restraint in accordance with embodiments of the present disclosure as seen in the trailer clamping position;

FIG. 7 is a cross-sectional top view of the trailer restraint in accordance with embodiments of the present disclosure as seen along Line 6-6 in FIG. 6A;

FIG. 8 is a cross-sectional side view of a trailer hook of the vehicle restraint in accordance with embodiments of the present disclosure as seen along Line 7-7 in FIG. 7;

FIG. 9 is a cross-sectional side view of the vehicle restraint and the trailer bar in accordance with embodiments of the present disclosure as seen with the vehicle restraint in the stored position;

FIG. 10 is a cross-sectional side view of the vehicle restraint and the trailer bar in accordance with embodiments of the present disclosure as seen with the vehicle restraint in the reconfiguration process between the stored position and the trailer clamping position;

FIG. 11 is a cross-sectional side view of the vehicle restraint and the trailer bar in accordance with embodiments of the present disclosure as seen with the vehicle restraint in the reconfiguration process between the stored position and the trailer clamping position;

FIG. 12 is a cross-sectional side view of the vehicle restraint and the trailer bar in accordance with embodiments of the present disclosure as seen with the vehicle restraint in the trailer clamping position; and

FIG. 13 depicts the vehicle restraint in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term trailer is intended to refer to a containment structure for holding goods, e.g., during transit between two or more shipping nodes. The trailer can be moved by a tow vehicle, such as a truck, a tractor, or other heavy-duty equipment. In some instances, the trailer can be permanently affixed to the tow vehicle, such as box trucks. The trailer typically includes a roof supported by sidewalls extending upward from a floor surface. A suspension links the floor surface to wheels. The suspension can include an air suspension, a leaf spring suspension, a rocker suspension, or yet other types of suspension components. The wheels are typically organized in blocks (sets) arranged closer to a rear end of the trailer. Landing gear located near the front of the trailer allows the trailer to be uncoupled from the tow vehicle without tipping the floor surface forward. When applicable, the landing gear may be retractable (e.g., through one or more powered components or hand cranks) to clear the tow vehicle when engaged therewith. A rear end of the trailer includes at least one door. Typically, the trailer includes two swing doors that centrally open and pivot about hinge points arranged at rear ends of the sidewalls or a rolling door depending on trailer design. Trailer lights are often disposed below the doors to signal to vehicles behind the trailer. A bumper (sometimes referred to as a trailer bar or a rig bar) and mudflaps may be disposed at a rear end of the trailer. Some trailers can include climate control features such as refrigeration units. The refrigeration unit may be mounted to a front of the trailer above a kingpin or to the roof. An electrical harness may extend from the front of the trailer to the rear thereof and provide power and/or communication between the various powered trailer components.

As used herein, the term facility is intended to refer to a wide range of structures, each of which accommodate the trailer at various stages of transport. The facility can define a shipping node at which goods are loaded and/or unloaded from the trailer. Example facilities include warehouses, distribution centers, manufacturing centers, delivery centers, or the like. The facilities typically include loading docks to which trailers can be backed up to. Once at the loading dock, the trailer door(s) can be opened to provide access to the trailer interior for loading and/or unloading good from the interior of the trailer.

Facilities often include equipment that helps workers to facilitate easier and safer access to the trailer and goods contained therein. The equipment is typically associated with an individual facility and remains at the facility after the trailer departs therefrom. Example equipment includes forklifts, hand trucks, conveyor systems, dock levelers, dock bumpers, dock doors, dock seals, dock shelters, dock lights, and the like. Cameras may be positioned at or near dock doors to view the loading dock area. The cameras may provide images (still or moving) to a facility controller (e.g., a dock door and/or a dock leveler controller). Sensors disposed at the facility can detect presence of the trailer(s) at the docked position. The sensors can be communicatively coupled with the facility controller and notify workers when a trailer is present at the dock door. For example, the controller can receive feedback from one or more sensors that a trailer is present at a particular loading dock door. The controller can then communicate with a nearby notification system (such as a notification system integrated into the dock controller), causing the notification system to alert workers of the trailer’s presence at the loading dock. The notification system may include one or more lights (e.g., a green light and a red light), a display (e.g., a touchscreen or non-touch display), or the like.

In some instances, the facility controller (e.g., the dock door controller associated with an occupied loading dock) can automatically initiate a trailer load/unload protocol in response to detecting presence of a trailer at one of the loading dock positions. Automatic initiation of the load/unload protocol can include automatically activating one or more equipment associated with the loading dock position (e.g., activating the dock leveler, opening the loading dock door, etc.), notifying workers of trailer presence at the loading dock position, or the like. In some instances, the facility controller can further cause loading equipment to become assigned with the trailers. Assignment of equipment may cause the equipment to become unavailable to other loading docks until the load/unload process is complete. In some implementations, assignment of equipment may further cause the equipment to autonomously, or semi-autonomously, navigate from a current position to the loading dock position. Yet further actions may be taken automatically in response to initiation of the trailer load/unload protocol.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, it is desirable to positively engage a trailer at a loading dock to prevent relative movement between the trailer and the loading dock. As described above, relative movement, particularly during loading and unloading of the trailer, can result in danger to workers entering and exiting the trailer. For example, if the trailer moves away from the loading dock, a gap is created between a rear end of the trailer and the loading dock wall. When using heavy equipment with limited visibility, the worker may not see the gap when entering or exiting the vehicle, causing a dangerous situation whereby the worker can fall into the gap and become injured by the equipment and/or the trailer moving back towards the loading dock. Embodiments described herein provide a low-profile vehicle restraint which allows for increased facility safety without compromising service vehicle access to the loading dock.

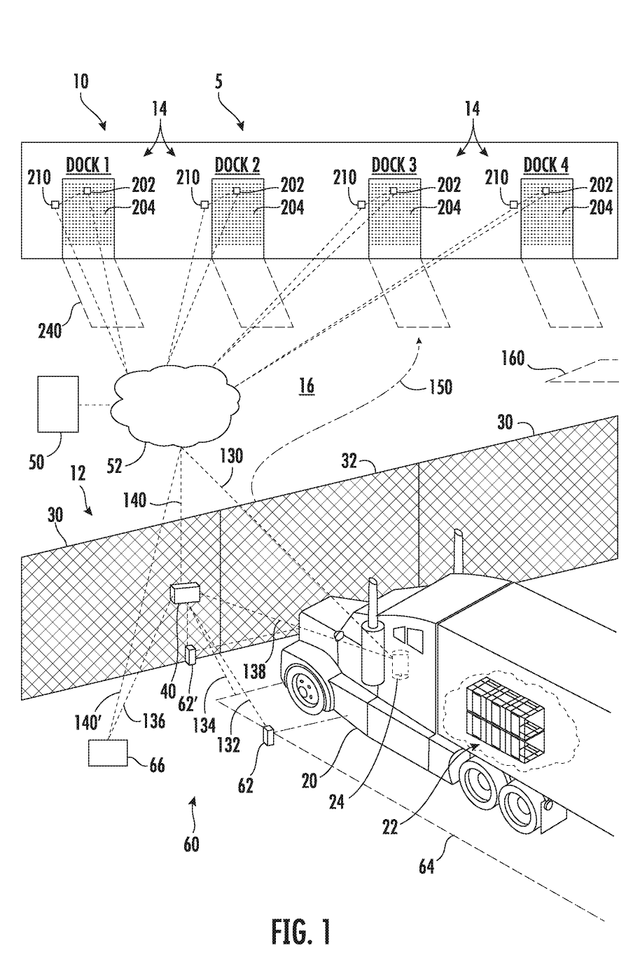

Referring now to the drawings, FIG. 1 illustrates a facility 10 including a perimeter barrier 12 that inhibits access to a secured premises 16. The facility 10 may be, for example, a warehouse, a shipping facility, an assembly plant, or the like. The facility 10 may include a plurality of loading docks 14 located within the secured premises 16 of the facility 10. A vehicle 20, which may be a tractor-trailer, flatbed truck, or cargo van as some examples, accesses the loading docks 14 via a movable barrier 32, such as a gate, of the perimeter barrier 12 to load or unload freight 22 at the loading docks 14. A user (e.g., the operator) of the vehicle 20 (e.g., truck) may operate one or more user devices 24 upon arrival at the perimeter barrier 12 to initiate opening of the movable barrier 32, and may operate the user device 24 upon arrival at a loading dock 14 to initiate opening of a movable barrier of the loading dock 14, such as a loading dock door 204.

The perimeter barrier 12 shown in FIG. 1 is in the form of a chain link fence having fixed barrier portions 30 and the movable barrier 32 that shifts relative to the fixed barrier portions 30. The movable barrier 32 shown in FIG. 1 may include rollers that travel along a track as the movable barrier 32 is shifted relative to the fixed barrier portions 30. In other embodiments, the movable barrier 32 may be include a swinging gate or door, a sectional garage door or one-piece “California” garage door, a roller door, a movable arm, tire spikes, or another suitable barrier for controlling access to the secured premises 16.

The facility 10 includes a system 5 for selectively permitting access to the facility 10. The system 5 includes a movable barrier operator 40, such as a gate operator, operatively connected to the movable barrier 32 to move the movable barrier 32 between a closed position and an open position. The movable barrier operator 40 may include or be in communication with an access control apparatus such as a telephone entry system-like panel that is configured to manage or control operation of the movable barrier operator 40. The access control apparatus may be configured with audio and/or video communication hardware such as a microphone, speaker, and/or camera such that the driver/operator of the vehicle may request access from an individual, e.g. a security guard, who is remote from the entrance or facility 10. Additionally or alternatively, the access control apparatus may include a credential receiver (e.g., biometric scanner, numeric keypad, card reader, etc.) that may authenticate, authorize or verify a user device 24 or user thereof. The system 5 includes a remote server computer 50 configured to communicate with the movable barrier operator 40 over a network 52. The remote server computer 50 may include one or more computers connected to provide operability as discussed below.

The remote server computer 50 is also configured to communicate with one or more sensors, indicated generally at 60. The sensors 60 may be located at the perimeter barrier 12 of the facility 10. In one embodiment, the sensors 60 communicate with the movable barrier operator 40, which communicates sensor data to the remote server computer 50. The communications between the sensors 60 and the movable barrier operator 40 may include wired and/or wireless approaches. In one embodiment, signals are communicated between the particular sensor 60 and the movable barrier operator 40 via another device (e.g., a proxy or a router).

The sensors 60 may be a presence detector that is configured to detect presence of a vehicle 20. For example, the sensors 60 may include a photo beam system 62 and/or a loop detector 64. Other presence sensors, indicated generally at 66, can include one or more of a passive infrared detector, camera, a radio frequency receiver, a short-range (e.g., Bluetooth) receiver, a magnetic detector, a light or sound-based time-of-flight sensor, a radio sensor, a capacitance detector, sound detector, and an optical detector (e.g., a camera). The sensors 60 may inform the movable barrier operator 40 and/or the remote server computer 50 of the presence of a vehicle 20 at the movable barrier 32 of the facility 10.

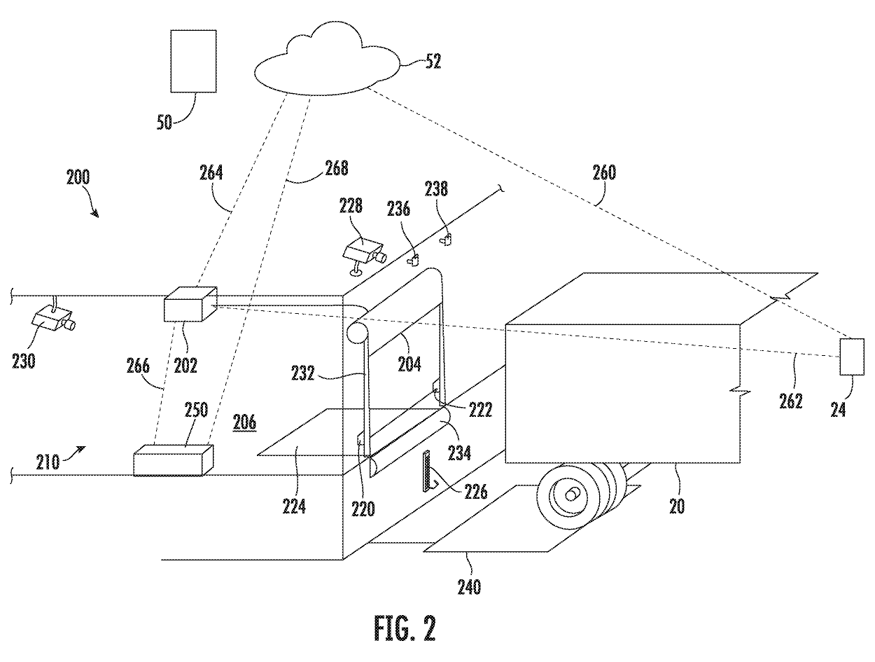

FIG. 2 illustrates a loading dock area 200 (which may correspond to the loading dock 14 of FIG. 1) including a dock door operator 202, which may or may not be present, that is configured to be operatively connected to a loading dock door 204 to move the loading dock door 204 between a closed position and an open position. The depicted loading dock door 204 is a roller door. However, the loading dock door 204 may be a paneled door, a swinging door, a gate, or other suitable barrier for controlling access to an interior 206 of the loading dock area 200.

The dock door operator 202, if present, may include a motor, communication circuitry, a memory, and a processor. The dock door operator 202 is configured to communicate via communication circuitry thereof with the remote server computer 50 over the network 52.

The loading dock area 200 may include one or more loading dock components, indicated generally at 210. Example loading dock components 210 include a photo beam system 220 including an emitter 222, a safety edging of the door 204, a dock leveler 224, a vehicle restraint 226 (e.g., a trailer lock), an exterior camera 228, an interior camera 230, edge guards or dock seal 232, dock bumper 234, an optical detector 236 (e.g., a camera or light time-of-flight sensor), a sensor 238 (e.g., a passive infrared (PIR), ultrasonic, and/or microwave sensor), a loop detector 240, and a radar presence sensor. One or more of the loading dock components 210 may be in communication (e.g., wired or wireless communication) with one or both of the dock door operator 202 and a gateway device 250. The gateway device 250 may be a communications hub that is in communication with the various loading dock components 210 and one or both of the dock door operator 202 and the remote server computer 50, but is not configured to move the loading dock door 204.

In one embodiment, the remote server computer 50 may send a control command to the dock door operator 202 and/or the gateway device 250 to configure at least one component of the loading dock components 210 to facilitate receiving the vehicle 20 at the loading dock area 200. Such a control or configuration command may be issued, for example, upon the conclusion of one or both of the check-in process and the presence verification process, and/or upon the remote server computer 50 causing the movable barrier operator 40 to move the movable barrier 32.

The one or more of the loading dock components 210 may be configured based at least in part on at least one characteristic of the vehicle 20. In one example, the remote server computer 50 may communicate a control command to cause a height adjustment of the dock leveler 224. The height adjustment may be based on a known height of a floor of the trailer associated with the vehicle 20 (e.g., as indicated by the check-in communication 130). In this way, the dock leveler 224 may provide an appropriate transition from a floor of the interior 206 of the loading dock area 200 to the load space associated with the vehicle 20. In still another example, the remote server computer 50 may communicate a control command to cause an adjustment of the operation of the vehicle restraint 226, such as adjusting an orientation of a vehicle restraint hook. As an example, the control command may cause an actuator to shift a carriage of the vehicle restraint 226 up or down along a vertical guide of the vehicle restraint 226. When the carriage has been shifted to the height requested by the control command, the hook of the vehicle restraint 226 is positioned to pivot up and over the rear impact guard of the vehicle 20 to secure the vehicle 20 at the loading dock. The rear impact guard of the vehicle 20 may correspond with a trailer bar of the trailer towed by the vehicle 20.

Upon the vehicle 20 arriving at the particular loading dock area 200, a “dock arrival” process is performed. More particularly, the remote server computer 50 may receive (e.g., at the communication interface 90) a dock arrival communication 260 from the user device 24 indicating arrival of the vehicle 20 at the particular loading dock area 200. In one embodiment, the dock arrival communication 260 is transmitted when a vehicle occupant opens and/or controls an application of the user device 24 via the user input 100 (e.g., via a touch screen). In this way, the vehicle occupant may manually affect transmission of the dock arrival communication 260 from the user device 24 upon arriving at the loading dock area 200. According to another aspect, the user device 24 may automatically affect transmission of the dock arrival communication 260. In this aspect, transmission of the dock arrival communication 260 may be affected in response to the processor circuit 118 determining (e.g., via location circuitry 112) that the user device 24 is at a predetermined geolocation or proximity relative to the loading dock area 200 (e.g., proximate the loading dock door 204). In one approach, the dock arrival communication 260 is communicated to the remote server computer 50 via the network 52. In another approach, the dock arrival communication 260 is communicated to the dock door operator 202 and/or the gateway device 250 for communication to the remote server computer 50 via the network 52.

Upon receiving the dock arrival communication 260, the remote server computer 50 may perform a dock presence verification process. More particularly, the remote server computer 50 may communicate (e.g., via the communication interface 90) with one or more devices at the loading dock area 200 to verify the vehicle 20 has arrived at the loading dock area 200.

In one aspect, the remote server computer 50 may communicate with the dock door operator 202 for verification of vehicle presence at the loading dock area 200. The dock door operator 202 and/or the gateway device 250 may be informed of a presence of the vehicle 20 at the loading dock area 200 through various approaches. In one approach, the dock door operator 202 and/or the gateway device 250 communicates with one or more of the loading dock components 210.

In one example, verification of the presence of the vehicle 20 may include detecting a break in an optical beam transmitted by a photo beam system 220. In another example, verification of the presence of the vehicle 20 may include detecting a change in the base frequency of the electrical signal transmitted by the loop detector 240. Other sensors and loading dock components 210, discussed above, may be used for detecting the presence of the vehicle 20 at the loading dock area 200, such as for example, a radar presence detecting system.

In another approach, the dock door operator 202 is configured to directly detect presence of a vehicle 20 at the loading dock area 200. For example, the communication circuitry of the dock door operator 202 may communicate with the user device 24, as indicated at signal 262. Such communication may be, for example, via a short-range protocol (e.g., Bluetooth).

As such, at least one of the dock door operator 202 and the gateway device 250 is informed of a presence (or absence as informed or inferred) of a vehicle 20 at the loading dock area 200. In one aspect, the dock door operator 202 is configured to transmit a dock verification communication 264 to the remote server computer 50. The dock verification communication 264 may be transmitted in response to, for example, the dock door operator 202 receiving a presence indication from a loading dock component 210 or the user device 24, or in response to receiving a signal 266 from the gateway device 250. Additionally or alternatively, the gateway device 250 may transmit a dock verification communication 268 to the remote server computer 50.

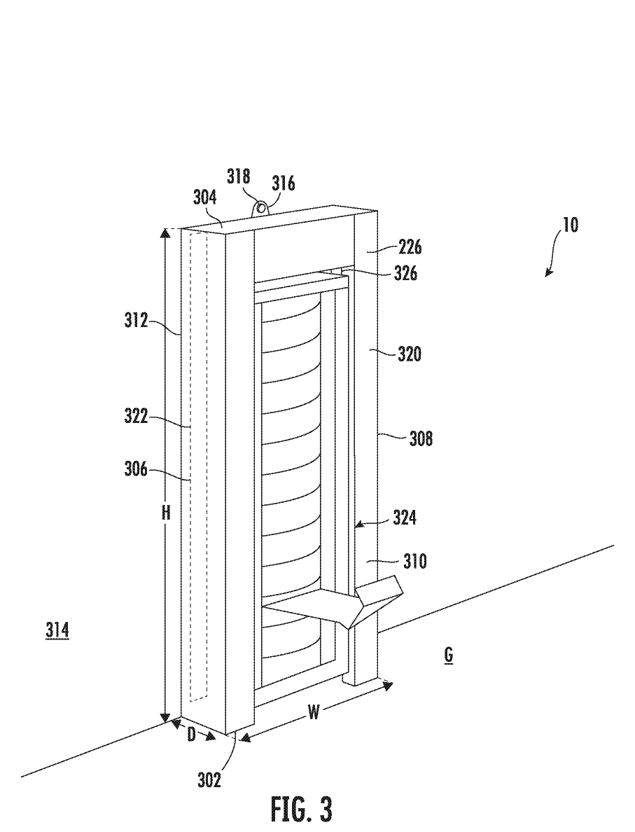

Referring to FIG. 3, an enlarged view of the vehicle restraint 226 is depicted on-site at the facility 10 without the presence of a trailer at the loading dock door 204 (FIG. 2). The vehicle restraint 226 is disposed near one of the loading dock doors 204 at a vertical elevation generally associated with a rear trailer bar of the trailer. For instance, the vehicle restraint 226 is depicted in FIG. 3 at ground level with a lower end 302 of the vehicle restraint 226 sitting at, or just above, a ground surface G. The vehicle restraint 226 remains at a relatively fixed location with respect to the loading dock door 204 vertically below the loading dock door 204.

The vehicle restraint 226 defines a height H, as measured from the lower end 302 to an upper end 304. The height H is less than a height from the ground surface G to the bottom of the loading dock door 204. The vehicle restraint 226 defines a width W, as measured from a first lateral end 306, such as a left side of the vehicle restraint 226, to a second lateral end 308, such as a right side of the vehicle restraint 226. In an embodiment, the height H of the vehicle restraint 226 is greater than the width W. For instance, H can be at least 110% of W, such as at least 115% of W, such as at least 120% of W, such as at least 125% of W, such as at least 130% of W, such as at least 135% of W, such as at least 140% of W, such as at least 145% of W, such as at least 150% of W. In an embodiment, H is at least 200% of W, or even at least 300% of W.

The vehicle restraint 226 further defines a depth D, as measured by a maximum distance from a front end 310 of the vehicle restraint 226 to a rear end 312 of the vehicle restraint 226. The depth D can be minimized to reduce the dimension by which the vehicle restraint 226 projects outwardly from the facility 10. By mounting the vehicle restraint 226 close to the facility, e.g., such that the rear end 312 of the vehicle restraint 226 contacts a sidewall 314 of the facility 10 and the front end 310 extends from the sidewall 314 by a minimum depth D, equipment can easily access the front of the loading dock. For example, debris removal equipment such as snowplows, blowers, bulldozers, and the like can operate in close proximity to the sidewall 314 of the facility 10 without impacting the vehicle restraint 226, thereby reducing the amount of worker labor required to maintain an operating condition of the loading dock, e.g., in the event of snow or debris accumulation. Traditionally, snowplows and other debris removal equipment used in close proximity to loading docks were required to maintain large clearances with respect to the facility 10 to avoid impacting large, bulky structures projecting from the facility 10. Workers were then required to manually complete the operation (e.g., snow or debris removal process) by hand (e.g., by digging out the bulky structures). Low profile vehicle restraints 226 like those described herein have depths D that minimally project from the sidewall 314 of the facility 10, thereby allowing equipment closer access to the facility 10 without risking impact and damage to the vehicle restraint 226. In this regard, worker labor and time required to prepare the facility 10 for vehicle arrival is reduced. As used herein, low profile vehicle restraints can have a depth D less than 48 inches or less than 36 inches. In some instances, low profile vehicle restraints 226 can have depths D less than 30 inches, such as less than 24 inches, such as less than 18 inches, such as less than 12 inches, such as less than 11 inches, such as less than 10 inches, such as less than 9 inches, such as less than 8 inches.

In some implementations, the height H of the vehicle restraint 226 is greater than the depth D. For instance, H can be at least 120% of D, such as at least 130% of D, such as at least 140% of D, such as at least 150% of D, such as at least 160% of D, such as at least 170% of D, such as at least 180% of D, such as at least 190% of D, such as at least 200% of D, such as at least 300% of D, such as at least 500% of D. The width W of the vehicle restraint 226 can also be greater than the depth D. For instance, W can be at least 101% of D, such as at least 105% of D, such as at least 110% of D, such as at least 115% of D, such as at least 120% of D, such as at least 125% of D, such as at least 130% of D, such as at least 135% of D. The height H can be greater than the width W and the width W can be greater than the depth D, i.e., H > W > D.

In the position/configuration depicted in FIG. 3, the vehicle restraint 226 can occupy a volume, as defined by a best fit cuboidal box bounding outermost points of the vehicle restraint 226 (with the exception of a trailer hook described below in greater detail), in a range of 0.05 cubic feet (cu. ft) and 7.5 cu. ft, such as in a range of 0.25 cu. ft and 5 cu. ft, such as in a range of 0.5 cu. ft and 2.5 cu. ft. In an embodiment, the vehicle restraint 226 can occupy at least 50% of the volume, such as at least 60% of the volume, such as at least 70% of the volume, such as at least 80% of the volume, such as at least 90% of the volume, such as at least 95% of the volume. In this regard, the vehicle restraint 226 can be efficiently deployed at the loading dock 204, minimizing wasted space as typically seen with traditional vehicle restraint systems.

The vehicle restraint 226 is fixedly coupled to a rigid structure at the loading dock foundation wall. For example, the vehicle restraint 226 may be coupled directly to the concrete sidewall 314 of the facility 10. Alternatively, or in addition, the vehicle restraint 226 can be coupled to a specific vehicle restraint supporting structure (not illustrated) such as a pier, a piling, a partition wall, a skirt, or the like disposed adjacent to the sidewall 314. In some installations, an intermediary structure 322 can be disposed between the vehicle restraint 226 and the sidewall 314. The intermediary structure 322 can include, for example, a supporting pad, a waterproof membrane, a mounting alignment structure that assists in aligning the vehicle restraint 226 during installation, a contact pad including sensors that detect force between the vehicle restraint 226 and the sidewall 314, another intermediary layers or layers, or any combination thereof.

The vehicle restraint 226 can be externally mounted to an exterior surface of the sidewall 314. That is, the rear end 312 of the vehicle restraint 226 can be coupled directly to the existing sidewall 314 of the facility 10. As such, the vehicle restraint 226 does not require special site-design considerations such as cutouts and/or internal storage locations in which portions of the vehicle restraint 226 are disposed. Accordingly, the vehicle restraint 226 can be retrofit to nearly any facility 10 or structure without requiring significant (or even any) modification thereof.

In an embodiment, the vehicle restraint 226 includes one or more fastener receivers 316 which each receive one or more fasteners 318 to anchor the vehicle restraint 226 to the underlying structure, e.g., the sidewall 314. In the depicted embodiment, the fastener receiver 316 extends upward from upper end 304 of the vehicle restraint 226 and receives a threaded fastener 318 (e.g., a bolt) that anchors directly to the sidewall 314. The vehicle restraint 226 can also, or alternatively, include fastener receiver(s) 316 at one or both of the lateral ends 306, 308 and/or at the lower end 302. The vehicle restraint 226 can also, or alternatively, include internally positioned fastener receiver(s) 316 that do not project outward from the lower, upper, or lateral ends 302, 304, 306, 308. For example, as described in greater detail below, the vehicle restraint 226 can include a central opening where the fastener receiver(s) 316 can be positioned. Yet further, in some implementations the fastener 318 can extend through a body 320 of the vehicle restraint 226, such as through an opening extending through the body 320. In some instances, the vehicle restraint 226 can be fastened to the underlying structure, e.g., the sidewall 314 by other means, such as non-threaded fasteners, adhesive, concrete and/or masonry, mechanical bonding or crimping, a quick connect or twist-to-connect interface, or the like.

FIG. 3 depicts the vehicle restraint 226 in a first (stored) position (sometimes referred to as a storage position). The vehicle restraint 226 can be disposed in the stored position when no trailer is present at the loading dock. For example, the vehicle restraint 226 can be reconfigured to the stored position when a previous trailer departs from the loading dock and before a subsequent trailer arrives at the loading dock. The vehicle restraint 226 may also be reconfigured to the stored position at the end of a workday, during a servicing and/or maintenance operation at the loading dock, in response to predicted inclement weather, or the like. In the stored position, the vehicle restraint 226 can exhibit a minimum depth D. In some instances, the depth D of the vehicle restraint 226 in the stored position can be sufficiently small such that the front end 310 of the vehicle restraint 226 is sheltered from inclement weather (e.g., rain and snow) by an overhanging roof or door seal structure.

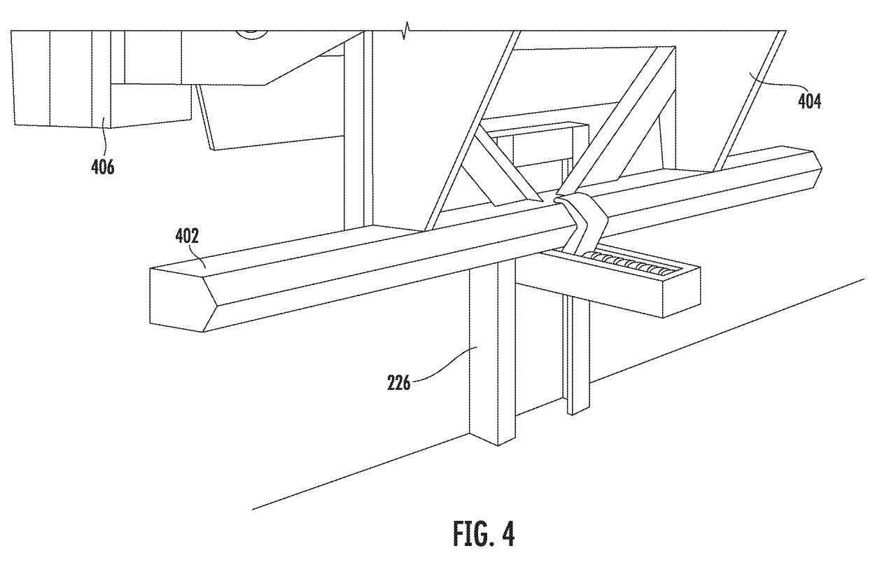

FIG. 4 depicts the vehicle restraint 226 in a second (trailer clamping) position. In the trailer clamping position, the vehicle restraint 226 engages with a rear trailer bar 402 of a trailer 404 to restrain relative motion of the trailer 404 and, more particularly, to prevent the trailer 404 from moving away from the loading dock 406, particularly when equipment and workers are entering and exiting the trailer 404, such as during a loading and/or unloading operation. As described in greater detail hereafter, the vehicle restraint 226 can apply a compressive force to the trailer bar 402 in the second position. The compressive force can bias the trailer bar 402, and thus the trailer 404, towards the loading dock 406, mitigating risk of the trailer 404 moving (i.e., rolling) forward due to the force of the workers and equipment entering/exiting the trailer 404; environmental forces such as wind, ground tremors; impact from another vehicle at the facility 10; or the like.

In some implementations, reconfiguring the vehicle restraint 226 between the stored position (FIG. 3) and the trailer clamping position (FIG. 4) is performed manually, or at least partially manually. That is, a worker can interact with the vehicle restraint 226 (directly or indirectly) to perform at least one operation to reconfigure the vehicle restraint 226 from the stored position to the trailer clamping position and/or from the trailer clamping position to the stored position. In other implementations, reconfiguring the vehicle restraint 226 between the stored and trailer clamping positions is performed autonomously, or semi-autonomously, using one or more powered components, such as one or more motors, engines, actuators, hydraulics, pneumatics, or the like. In a particular embodiment, the vehicle restraint 226 includes one or more powered component(s), such as one or more electric motors (e.g., direct current (DC) motors), coupled to a main power source. The electric motor(s) can receive control signals from a local controller, such as the gateway device 250 (FIG. 2), a loading dock controller, a remote server computer 50 (FIG. 2), a user device (such as a tablet controlled by a nearby worker), onboard control circuitry (such as described below), or the like. The control signals received at the electric motor(s) can control, for example, a current state of the vehicle restraint 226, a future state of the vehicle restraint 226, one or more settings of the vehicle restraint 226 (such as motor speed, compressive force, etc.), or the like.

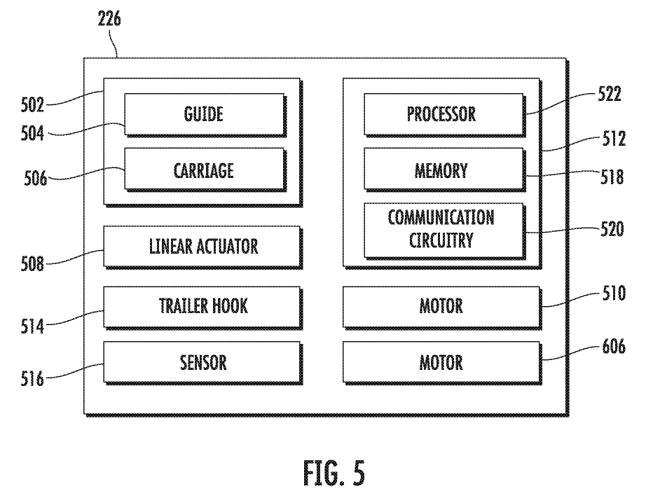

FIG. 5 illustrates a schematic of the vehicle restraint 226 in accordance with an example embodiment. As depicted in FIG. 5, the vehicle restraint 226 can include a guide assembly 502 including a guide 504 and a carriage 506. The guide 504 can be part of, e.g., unitary with, the body 320 (FIG. 3) of the vehicle restraint 226. For example, as depicted in FIG. 3, the body 320 of the vehicle restraint 226 can define a receiving area 324, such as a centrally-positioned opening extending at least partially through the body 320, e.g., in the depth D dimension. In some instances, the receiving area 324 can extend fully through the body 320, i.e., between opposite ends thereof. In other instances, the receiving area 324 can define a recess extending from a first end of the body 320 and terminating prior to reaching another, i.e., opposite, second end of the body 320. The receiving area 324, or a portion associated therewith, can define the guide 504. In some implementations the guide 504 can define a track 326 in which the carriage 506 moves within. The track 326 can include, for example, guide rails or channels which capture the carriage 506 and restrict the carriage to a predefined allowable range of motion. The carriage 506 can move relative to the guide 504 as part of the reconfiguration process between the storage position (FIG. 3) and the trailer clamping position (FIG. 4).

The carriage 506 can be movably coupled to the guide 504 at the receiving area 324. For example, the carriage 506 can be pivotably coupled to the guide 504. Additionally, or alternatively, the carriage 506 can be translatably coupled to the guide 504. In some implementations, reconfiguring the vehicle restraint 226 between the storage and trailer clamping positions can include rotating the carriage 506, translating the carriage 506, or both rotating and translating the carriage 506 relative to the guide 504. In some instances, a single reconfiguring process (i.e., moving from the stored position to the trailer clamping position or from the trailer clamping position to the stored position) can include moving the carriage 506 in different directions at different steps of the reconfiguration process. For instance, by way of non-limiting example, the reconfiguring process can include initially translating the carriage 506 along the track 326 in a first direction (e.g., a downward direction) from a first position to a second position. The reconfiguring process can then include translating the carriage 506 along the track 326 in a second direction (e.g., an upward direction) from the second position to a third position. The first position can correspond to the stored position and the third position can correspond to the trailer clamping position. The second position can correspond to an intermediary position between the stored position and the trailer clamping position that allows alignment of the vehicle restraint 226 with respect to the trailer bar 402 (FIG. 4). While the second position is described as a discrete position, the reconfiguration process may cause the carriage 506 to pass continuously from the first to third positions without stopping at any single, discernable second position.

As depicted in FIG. 5, the vehicle restraint 226 further includes an actuator, such as a linear actuator 508. The linear actuator 508 can be coupled to the carriage 506. Movement of the carriage 506 can thus affect a spatial position of the linear actuator 508 relative to the body 320. In an embodiment, the linear actuator 508 is pivotably coupled to the carriage 506. Rotation between the linear actuator 508 and the carriage 506 can occur about a generally horizontal axis. In this regard, rotation of the linear actuator 508 relative to the carriage 506 can cause the linear actuator 508 to move from an upright (i.e., vertical orientation) to a horizontal, or generally horizontal, orientation.

By way of non-limiting example, the linear actuator 508 can include an electric linear actuator (such as a direct current (DC) or alternating current (AC) motor actuated linear actuator), a hydraulic linear actuator (such as a single-acting hydraulic cylinder or a double-acting hydraulic cylinder), a pneumatic linear actuator (such as a single-acting pneumatic cylinder or a double-acting pneumatic cylinder), a mechanical linear actuator (such as a screw jack, a lead screw, or a ball screw), a piezoelectric or shape memory allow (SMA) linear actuator, a cable-driven linear actuator, a chain-driven linear actuator, or the like. In some implementations, the linear actuator 508 is driven by an onboard motor 510 which is coupled to control circuitry 512 of the vehicle restraint 226. The motor 510 drives the linear actuator to move a trailer hook 514 between two or more different positions. For example, the motor 510 can drive the trailer hook 514 to move between a first position as depicted in FIG. 3 and a second position as depicted in FIG. 4. The first position can correspond with the stored position and the second position can correspond with the trailer clamping position. The motor 510 can drive the linear actuator 508 to selectively move the trailer hook 514 in both directions, i.e., from the first position to the second position or from the second position to the first position.

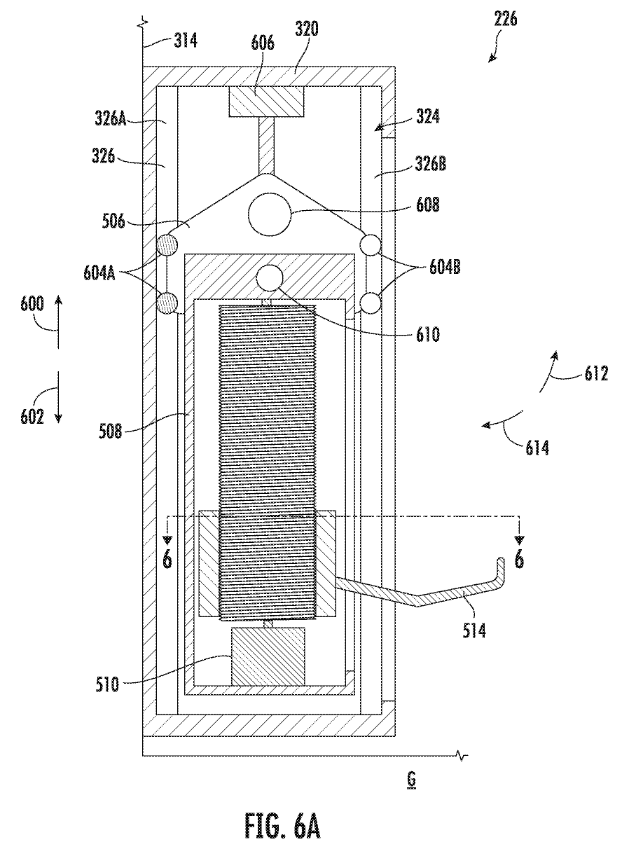

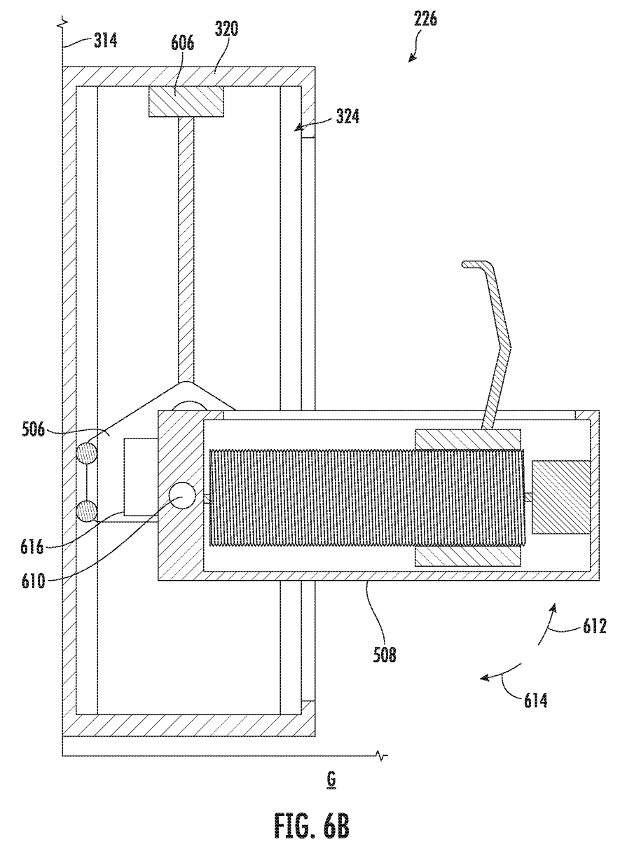

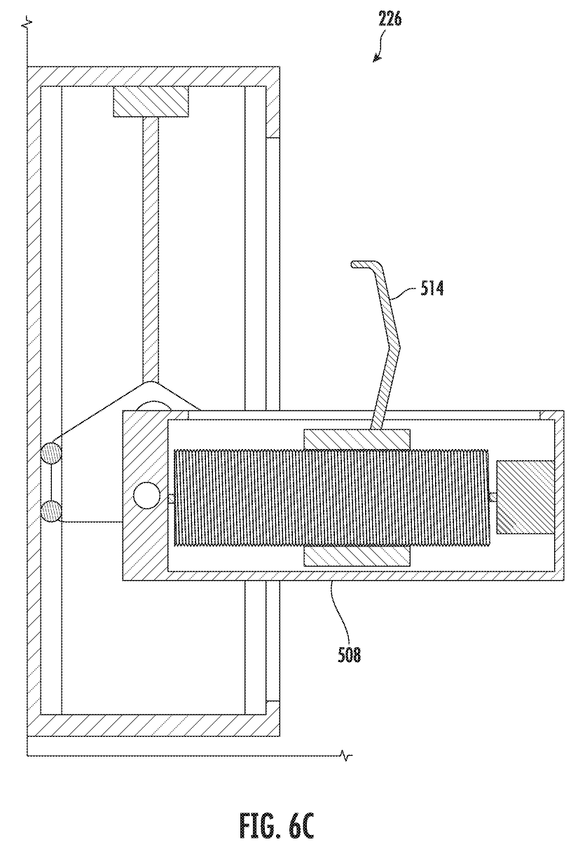

FIGS. 6A to 8 depict various cross-sectional views of the vehicle restraint 226 and portions thereof in accordance with an example embodiment. More particularly, FIGS. 6A-6C are cross-sectional side views of the vehicle restraint 226 in accordance with an example embodiment undergoing reconfiguration between the stored position and the trailer clamping position; FIG. 7 is a cross-sectional top view of a portion of the linear actuator 508 in accordance with an embodiment as seen at Line 6-6 in FIG. 6; and FIG. 8 is a cross-sectional side view of the trailer hook 514 in accordance with an embodiment as seen at Line 7-7 in FIG. 7.

Referring initially to FIG. 6A, the body 320 defines the receiving area 324 in which the linear actuator 508 is at least partially disposed in at least the first (stored) position. The track 326 can define a guide surface that guides the carriage 506 to move along the body 320. As depicted, the track 326 can include a plurality of tracks, such as a first track 326A and a second track 326B (collectively referred to as the track 326). The carriage 506 is translatable relative to the body 320 in the vertical directions (i.e., in the upward direction 600 and/or the downward direction 602). The carriage 506 can be supported by one or more guide components, such as one or more bearings or rollers or a gear and chain. The guide components can include a first roller (or first set of rollers) 604A that are guided by the first track 326A and a second roller (or a second set of rollers) 604B that are guided by the second track 326B. The rollers 604A, 604B can provide a low friction interface for the carriage 506 to move along the track 326 as the carriage 506 moves in the directions 600, 602. The carriage 506 can be driven in the directions 600, 602 by an actuator 606. The actuator 606 can include, for example, a motorized linear actuator or a servo actuator. The actuator 606 can be coupled to the body 320 and extend towards the carriage 506. In an embodiment, the actuator 606 is coupled to the body 320 at an upper end of the receiving area 324 and extends downward towards the carriage 506. The carriage 506 be coupled to the actuator 606 at an attachment point 608. The attachment point 608 can include, for example, a pinned connection which allows the carriage 506 to be detached from the actuator 606, e.g., for service, maintenance, or replacement. The actuator 606 is configured to receive control signals, e.g., from the control circuitry 512, causing the actuator 606 to selectively drive the carriage 506 in the upward direction 600 or the downward direction 602. In some instances, the actuator 606 may further affect another condition of the carriage 506. For example, the actuator 606 may cause the carriage 506 to rotate, e.g., about the attachment point 608, or impact one or more physical aspects of the linear actuator 508, such as driving the linear actuator 508 to cause the trailer hook 514 to move between the first and second positions. That is, in some implementations, the actuator 606 can replace the motor 510. In yet other instances, the motor 510 can affect the condition of the carriage 506. For example, the motor 510 can cause the carriage 506 to move in the upward 600 and/or downward 602 directions.

FIG. 6B depicts the carriage 506 in a lowered position, i.e., driven downward by the actuator 606. The lowered position may refer to a lowermost position of the carriage 506 with respect to the receiving area 324 or a relatively lower position of the carriage 506 with respect to the receiving area 324 (i.e., not necessarily the lowest position).

The linear actuator 508 can be pivotably coupled to the carriage 506 at a pivot point 610. By way of non-limiting example, the pivot point 610 can include a bushing, a bearing, or a pinned connection formed between the linear actuator 508 and the carriage 506. The linear actuator 508 can pivot about the pivot point 610 in a first direction 612 and a second direction 614 opposite the first direction 612. Pivoting in the first direction 612 may be associated with reconfiguring the vehicle restraint 226 to the trailer clamping position (FIG. 6C). Pivoting in the second direction 614 can be associated with reconfiguring the vehicle restraint 226 to the stored position (FIG. 6A). In an embodiment, pivoting of the linear actuator 508 about the pivot point 610 is caused by motion of the actuator 606. For example, a linkage 616 can couple the actuator 606 to the linear actuator 508. The linkage 616 can include, for example, a transmission element that is selectively movable between an engaged position and a disengaged position. In the engaged position, movement of the actuator 606 can be transmitted to the linear actuator 508, causing the linear actuator 508 to pivot. In the disengaged position, movement of the actuator 606 can be disconnected from the linear actuator 508. In an embodiment, movement of the carriage 506 relative to the guide 504 may occur when the transmission element is in the disengaged position. That is, the transmission can selectively couple the actuator 606 to the carriage 506 and the linear actuator 508, e.g., one at a time. The state of the transmission (i.e., engaged or disengaged) may be affected by a control unit, such as a servo motor (not illustrated). The control unit can receive control signals, e.g., from the control circuitry 512, that causes the control unit to adjust the state of the transmission.

As described above, the linear actuator 508 is drivable between two or more positions to affect a state of the trailer hook 514. FIG. 6B illustrates the trailer hook 514 in a first position, as seen when the vehicle restraint 226 is not actively engaged with (i.e., restraining) a trailer. FIG. 6C illustrates the trailer hook 514 in a second position, as seen when the vehicle restraint 226 is actively engaged with (i.e., restraining) the trailer. The following description relates to an example method of moving the linear actuator 508 between the first and second positions.

As depicted in FIG. 7, the linear actuator 508 can include a screw 700 having one or more, e.g., a plurality of, helical threads 702 disposed along an outer surface 704 of the screw 700. The trailer hook 514 can include one or more complementary threads 706 that interface with the helical thread(s) 702 of the screw 700. For example, the trailer hook 514 can include an aperture 708 through which the screw 700 extends. The helical thread(s) 702 of the screw 700 can interface with helical thread(s) 706 of the trailer hook 514. The motor 510 can rotatably drive the screw 700 to rotate in a clockwise direction 712 or a counterclockwise direction 714. A frame 716 can restrain rotational motion of the trailer hook 514 in response to rotation of the motor 510, causing the threaded engagement between the helical threads 702, 706 to raise and lower the trailer hook 514 (i.e., into and out of the page as depicted in FIG. 7) as the motor 510 rotatably drives the screw 700.

In an embodiment, the motor 510 and the screw 700 can be coupled to the frame 716. The motor 510 can be disposed at a longitudinal end of the screw 700, statically fixed to the frame 716. The screw 700 can be rotatably coupled to the frame 716 and configured to rotate about a rotational axis 718 when driven by the motor 510. In an embodiment, the screw 700 can be coupled to the frame 716 through one or more bearings or bushings (not illustrated) which provide a low friction interface between the screw 700 and frame 716. As described above, the frame 716 can prevent the trailer hook 514 from rotating as the screw 700 is driven by the motor 510. In some implementations, the frame 716 includes one or more guides 720 that interact with the trailer hook 514 to mitigate relative rotation between the trailer hook 514 and the frame 716 during rotation of the screw 700. It should be understood that while reference is made herein to the screw 700, other types of linear actuators can be utilized which operate with different operating principles and do not require rotation of a threaded interface. For example, the linear actuator 508 can include a pneumatic or hydraulic actuator which operates under pneumatic or hydraulic principles. Alternatively, or in addition, the linear actuator 508 can include an infinite chain which is driven by a motor to move the trailer hook 514 between the first and second positions. Yet other configurations and operating principles are contemplated herein.

Based on the direction the motor 510 rotates (i.e., the clockwise or counterclockwise direction 712, 714), the trailer hook 514 is caused to translate either from the first position to the second position or from the second position to the first position. In some implementations, the trailer hook 514 may be located at an intermediate position between the first and second positions when the motor 510 starts to drive the screw. In these instances (unless intended otherwise), the terms first position and second position refer to relative positions, i.e., the first position is closer to the storage position and the second position is closer to the trailer clamping position. Thus, as used herein, movement between the first and second positions does not necessarily require full displacement of the trailer hook 514 between absolute ends of travel, but instead can refer to relative directions of displacements.

FIG. 8 illustrates a cross-sectional, side view of the trailer hook 514 in accordance with an example embodiment as seen along Line 7-7 in FIG. 7. As depicted, the trailer hook 514 includes a base 800 and an arm 802 extending from the base 800. The base 800 can include the aperture 708 defining the thread(s) 706 that interact with the threads 702 of the screw 700 (FIG. 7). The base 800 receives the screw 700 and travels along a length thereof in response to rotation of the screw 700. The arm 802 extends from the base 800, such as from an outer sidewall 804 of the base 800. In an embodiment, the arm 802 is unitary with the base 800. For example, the base 800 and arm 802 can be cast as a single piece and machined to form thread(s) 706. Alternatively, the arm 802 can be attached to the base 800, e.g., by a weld, an adhesive, a mechanical deformation process, a fastener or fasteners, or the like. In some instances, the arm 802 may be detachable from the base 800.

The arm 802 defines a profile that can receive and engage with the trailer bar 402. Trailer bars 402 exist in a range of shapes and sizes but generally include a polygonal cross section. To accommodate the different known trailer bars 402, the arm 802 can define a first portion 806 and a second portion 808. The first portion 806 can form a compression surface 810 against which the trailer bar 402 is compressed when the trailer hook 514 is driven towards the trailer bar 402 in the direction 812. The second portion 808 can include a flange or retaining surface 814 that prevents the trailer bar 402 from detaching from the first portion 806 of the arm 802. In an embodiment, the first portion 806 can be shaped to interface with pentagonal trailer bars 402 (which account for a large portion of known trailer bar shapes) without deforming a leading end of the trailer bar 402. The shaped first portion 806 can include a first segment 816 and a second segment 818 that are angularly offset from one another. The angular offset may accommodate the angular offset at the leading end of the trailer bar 402.

The arm 802 can be formed from a substantially rigid material, disallowing relative motion of any component thereof with respect to the base 800. In this regard, substantially all force applied on the trailer hook 514 by rotation of the screw 700 (FIG. 7) is directed to the trailer bar 402 to restrain the trailer bar 402 and prevent movement of the trailer 404 (FIG. 4). In some instances, the arm 802 (or a portion thereof) can exhibit a nominal amount of flexure in response to force when compressed against the trailer bar 402. This flexure can allow the arm 802 to adapt and accommodate to trailer bars 402 of varying shape and size. In some instances, the compression surface 810 can include an accommodation component, such as a rubber sheet 820 that rests against the trailer bar 402 when the trailer hook 514 is biased thereagainst. The rubber sheet 820 can deform to accept trailer bars 402 of varying shape and size without damaging the trailer bar 402 or marring the arm 802.

In an embodiment, the arm 802 can be detachable from the base 800 to allow swapping between different sized and/or different shaped arms 802. Alternatively, or in addition, the trailer hook 514 can be removable from the screw 700 (FIG. 7) to permit swapping between different sized and/or different shapes trailer hooks 514. While the arm 802 described above accommodates a wide range of trailer bars 402, in some instances it may be desirable to swap the arm 802 to accommodate a specialized trailer bar 402 or another type of trailer component.

Referring again to FIG. 5, the vehicle restraint 226 can further include a sensor 516. The sensor 516 can detect a characteristic of the vehicle restraint 226, such as a force applied by the vehicle restraint 226 on the trailer bar 402 (FIG. 4). The sensor 516 can be in communication with the control circuitry 512 and provide sensor data to the control circuitry 512.

In one implementation, the sensor 516 can be disposed at the trailer hook 514, such as along the compression surface 810 (FIG. 8). The sensor 516 can include a pressure sensor that detects pressure between the compression surface 810 and the trailer bar 402. In another implementation, the sensor 516 can include a strain gauge that detects material deformation of the trailer hook 514, such as deformation incurred within the arm 802 as a result of applying force against the trailer bar 402. In another implementation, the sensor 516 can include a contact sensor disposed along the compression surface 810 that detects contact with the trailer bar 402. In another implementation, the sensor 516 can include a visual or light sensor disposed at the compression surface 810 that detects presence of the trailer hook 402 when the trailer hook 402 blocks light from entering a sensor eye associated with the visual or light sensor.

In another implementation, the sensor 516 can include a current sensor that detects current draw of the motor 510. In some instances, the current sensor can be integral with the motor 510 itself. In other instances, the current sensor can include a discrete sensor coupled with the motor 510, such as in series therewith. The control circuitry 512 can determine force on the trailer bar 402 based on known qualities of the vehicle restraint 226 in view of the detected current draw. For example, the control circuitry 512 can include a look up table or reference database listing motor current draw and associated force applied by the trailer hook 514. The look up table or reference database can be saved locally, e.g., at a memory 518 of the control circuitry 512, or remotely, such as at the remote server computer 50.

Yet other types of sensors 516 are contemplated herein, such as contact sensors disposed at one or both ends of the screw 700, or locations along the length of the screw 700, to detect positional information associated with the trailer hook 514. Yet further, the screw 700 can include an encoder that detects an angular displacement of the screw 700. The control circuitry 512 can receive sensor data indicating angular displacement of the screw 700 to determine positional information of the trailer hook 514 and/or force applied on the trailer bar 402.

Sensor data is communicated (fed) to the control circuitry 512 for processing. The control circuitry 512 can include communication circuitry 520 that interfaces with the sensor 516 and a processor 522. The communication circuitry 520 communicates received information to the processor 522 which can access information and/or instructions stored in memory 518 to perform one or more operations described herein. The processor 522 can include any suitable processing device (e.g., a control circuitry, a processor core, a microprocessor, an application specific integrated circuit, a field programmable gate array, a controller, a microcontroller, etc.) and can be one processor or a plurality of processors that are operatively connected. The memory 518 can include one or more non-transitory computer-readable storage media, such as RAM, ROM, EEPROM, EPROM, one or more memory devices, flash memory devices, etc., and combinations thereof. The memory 518 can store information that can be accessed by the processor(s) 522. For instance, the memory 518 (e.g., one or more non-transitory computer-readable storage mediums, memory devices) can include computer-readable instructions that can be executed by the processor(s) 522. The instructions can be software, firmware, or both written in any suitable programming language or can be implemented in firmware or hardware. Additionally, or alternatively, the instructions can be executed in logically and/or virtually separate threads on processor(s) 522. For example, the memory 518 can store instructions that when executed by the processor(s) 522 cause the processor(s) 522 to perform operations such as any of the operations and functions as described herein.

In an embodiment, the sensor 516 can communicate detected sensor data to the control circuitry 512 which processes the sensor data and provides control instructions to the motor 510 in response to the processed sensor data. In some instances, the control circuitry 512 can activate the motor 510 to drive the screw 700 until the control circuitry 512 determines the trailer hook 514 is at a prescribed condition. For example, once a prescribed load is applied on the trailer bar 402 by the trailer hook 514, the control circuitry 512 can terminate further driving of the motor 510, thereby preventing the motor 510 from burning out and/or destroying the vehicle restraint 226 and/or trailer bar 402. The actual load can be determined, for example, in response to sensor data provided to the control circuitry 512 by the sensor 516. The control circuitry 512 can compare the actual load to a prescribed load stored, e.g., at memory 518. In response to the actual load reaching the prescribed load, the control circuitry 512 can send a control signal to terminate further actuation of the motor 510. In some instances, the motor 510 can remain active to hold the trailer hook 514 at the current position. In other instances, the motor 510 and/or screw 700 or other component of the vehicle restraint 226 can be locked out to hold the trailer hook 514 at the current position.

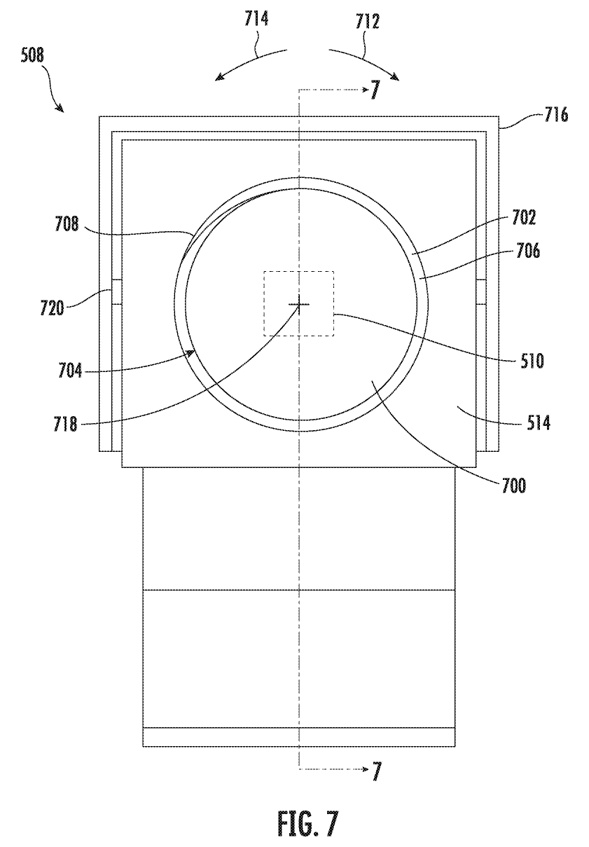

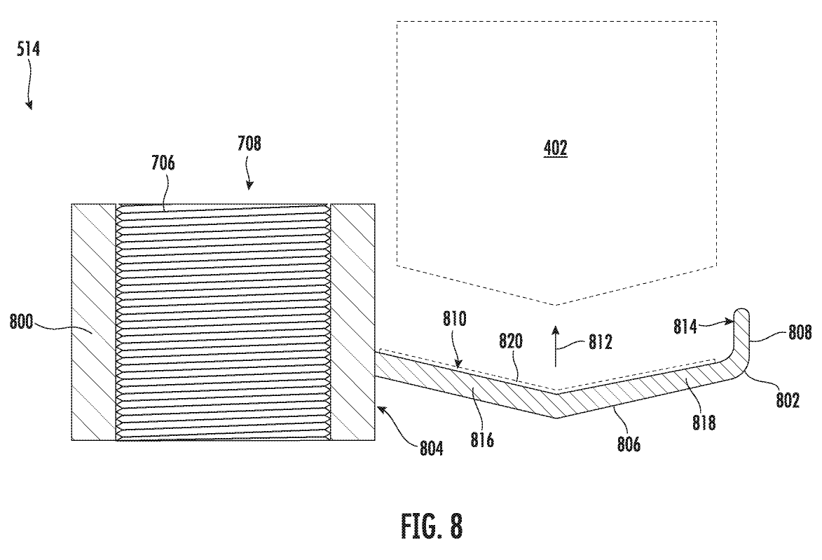

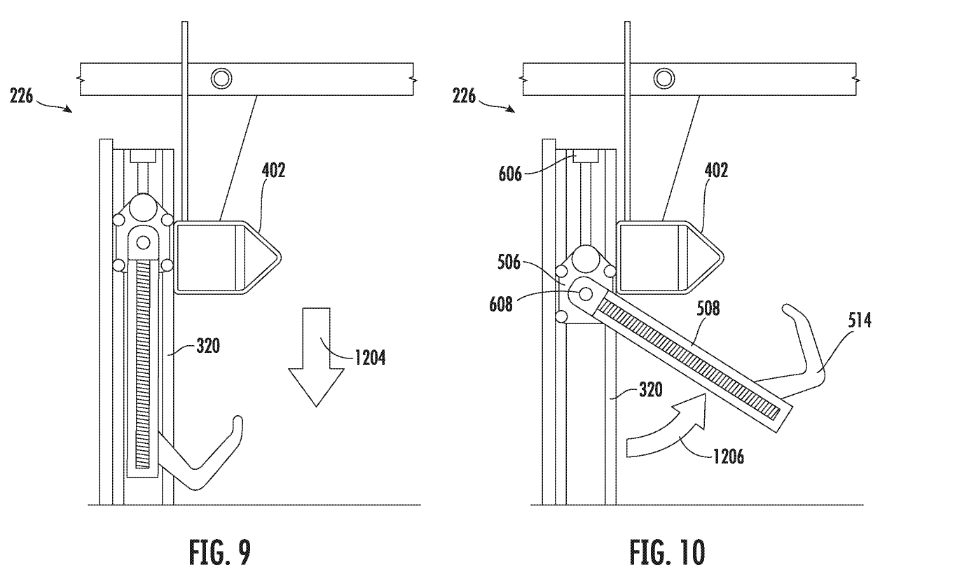

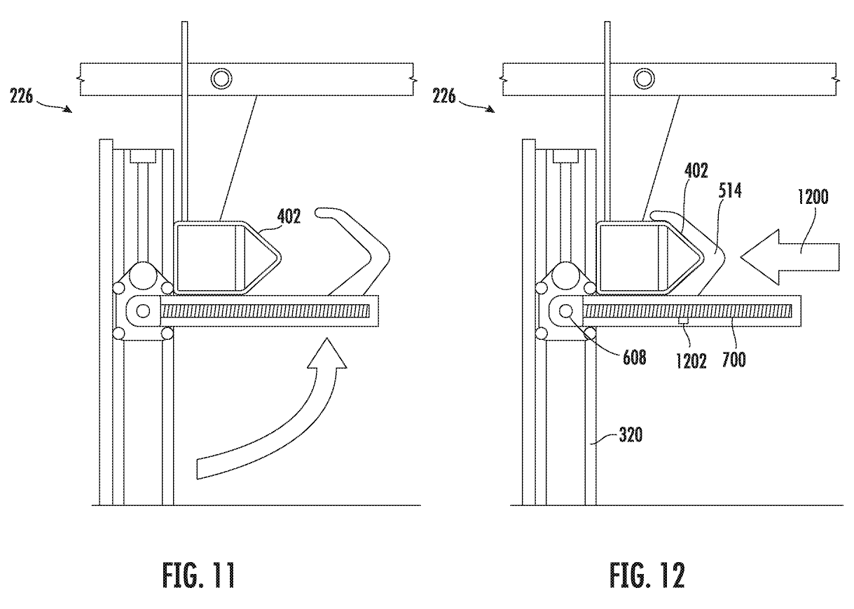

FIGS. 9 to 12 illustrate cross-sectional side views of the vehicle restraint 226 as seen in various positions. In particular, FIG. 9 depicts the vehicle restraint 226 in the first (stored) position and FIG. 12 depicts the vehicle restraint 226 in the second (trailer clamping) position. FIGS. 10 and 11 depict intermediary positions between the first and second positions.

Referring initially to FIG. 9, the vehicle restraint 226 is typically in the stored position prior to trailer arrival at the loading dock. Upon arrival, drivers typically back the trailer to the prescribed loading dock until the trailer reaches a parking location whereby the trailer bar 402 is adjacent to the vehicle restraint 226. In some instances, the driver may continue to back the trailer up towards the vehicle restraint 226 until a portion of the trailer, such as the trailer bar 402, contacts the vehicle restraint 226. As depicted in FIG. 9, this contact can occur between the trailer bar 402 and the body 320. In some implementations, the vehicle restraint 226, or a nearby component, can include a sensor that detects contact between the trailer bar 402 and the body 320. The sensor can include, for example, an interruptible photobeam, a contact sensor, a magnetic sensor, or another type of sensor. The sensor can transmit an arrival signal to the control circuitry 512 (FIG. 5) to signal arrival of the trailer at the vehicle restraint 226.

In some instances, the vehicle restraint 226 can automatically initiate the reconfiguration process from the first position (FIG. 9) to the second position (FIG. 12) in response to receiving the arrival signal from the sensor. In other instances, a worker (such as onsite personnel or the vehicle operator) may be required to take one or more actions prior to the vehicle restraint 226 undergoing the reconfiguration process. For example, the arrival signal can cause the control circuitry 512 to notify a user (e.g., through a user device) of the arrival. The user can select to initiate trailer engagement, upon which the vehicle restraint 226 can begin the reconfiguration process.

FIG. 10 illustrates the vehicle restraint 226 as seen during an initial step of the reconfiguration process. During the initial step of the reconfiguration process, the carriage 506 may be driven in a downward direction 1204 (FIG. 9) and the actuator 508 may rotate outward from the body 320 in an outward direction 1206. In some instances, driving the carriage 506 in the downward direction 1204 can occur prior to rotating the actuator 508 outward in the outward direction 1206. In other instances, rotating the actuator 508 outward in the outward direction 1206 can occur prior to driving the carriage 506 in the downward direction 1204. In yet other instances, driving the carriage 506 in the downward direction 1204 and rotating the actuator 508 in the outward direction 1206 can occur simultaneously. In yet other instances, the carriage 506 can remain at a relatively fixed location (i.e., not driven in the downward direction 1204) as the actuator 508 rotates outward in the outward direction 1206.

In some implementations, relative ramp speeds (i.e., actuation profiles) of motion relating to driving the carriage 506 in the downward direction 1204 and rotating the actuator 508 in the outward direction 1206 can be different from one another. For example, relatively low trailer bars 402 require the carriage 506 to be driven further in the downward direction 1204 to reach below the trailer bar 402 as compared to relatively high trailer bars 402. Thus, for relatively lower trailer bars 402, the carriage 506 drives the actuator 508 further in the downward direction 1204 before the actuator 508 rotates in the outward direction 1206. However, the actuator 508 may be required to rotate outward after some initial downward displacement to prevent impact with the underlying ground surface. The relative translation and rotation can be controlled, for example by the control circuitry 512. By way of example, the control circuitry 512 can receive sensor data, e.g., from a local sensor, or shipping data, e.g., from a shipping manifest or the remote server 50, and determine a speed profile for controlling the actuator 606 and for controlling articulation (rotation) of the actuator 508 based on the height of the trailer bar 402.

In some implementations, the trailer hook 514 remains in the lowermost position with respect to the actuator 508 while the actuator 508 is rotated in the outward direction 1206. In some instances, the trailer hook 514 can remain in the lowermost position until the actuator 508 is fully rotated to a final rotational position (FIG. 11) and before initiation of the next step of the reconfiguration process (FIG. 12). In other instances, the trailer hook 514 can begin moving towards the pivot point 608 while the actuator 508 rotates outward. In yet other instances, the trailer hook 514 can begin moving towards the pivot point 608 prior to or simultaneously with rotation of the actuator 508 in the outward direction 1206.

Driving the carriage 506 downward and rotating the actuator 508 outward can be performed in a manner such that the trailer hook 514 is positioned to engage with the trailer bar 402. That is, the reconfiguring process causes the trailer bar 402 to be received between the body 320 and the trailer hook 514. Once the trailer hook 514 is sufficiently positioned such that the trailer hook 514 can interact with the trailer bar 402, such as depicted in FIG. 11, the trailer hook 514 is caused to move in direction 1200 (FIG. 12) towards the pivot point 608, e.g., by rotation of the screw 700.

In some implementations, the trailer hook 514 can move in the direction 1200 towards the pivot point 608 at a uniform speed. In other implementations, the trailer hook 514 can move in the direction 1200 towards the pivot point 608 at a variable speed. For instance, the trailer hook 514 may be initially moved at a first speed and subsequently moved at a second speed different than the first speed. The second speed may be slower than the first speed. In this regard, contact between the trailer hook 514 and the trailer bar 402 may create less impulse shock to the trailer which might jolt the trailer in the event the trailer was not already in contact with the body 320. The first and second speeds can include discrete speeds that are separated by a sudden speed change. Alternatively, the first and second speeds can include a ramped speed profile without any discernable speed change. That is, the trailer hook 514 can be driven at a sequentially slower speed over the length of travel towards the pivot point 608.

The trailer hook 514 can be driven towards the pivot point 608 until reaching a prescribed threshold. By way of example, the prescribed threshold can include a force threshold (such as a force detected by a sensor of the vehicle restraint 226), a motor limiting threshold (such as, for example, a maximum current or power draw), a distance-travelled threshold (such as after the trailer hook 514 moves a certain distance towards the pivot point 608), or the like. Upon reaching the prescribed threshold, the trailer hook 514 can terminate further movement. For example, the screw 700 may no longer be driven. In some instances, a locking procedure can then occur. The locking procedure can prevent the trailer hook 514 from loosening relative to the trailer bar 402. That is, the locking procedure locks the trailer hook 514 at a relatively fixed location to lock the trailer to the loading dock. In some instances, the locking procedure can occur internally at the motor. For example, the motor can maintain current draw and remain activated. By way of another example, a locking implement 1202, such as a solenoid-activated locking member, can be deployed to lock the trailer hook 514. The vehicle restraint 226 can remain locked for the duration of the loading/unloading operation or until the trailer departs from the loading dock.

To unlock the trailer bar 402, the steps described above can be repeated in reverse. That is, the trailer hook 514 can be moved away from the pivot point 608, the actuator 508 can be rotated in an inward direction opposite the outward direction 1206 (FIG. 10), and the carriage 506 can be driven in an upward direction opposite the downward direction 1204 (FIG. 9). In some implementations, the vehicle restraint 226, and more particularly the control circuitry 512, can track the position(s) of at least one of the carriage 506 and/or actuator 508. Based on the tracked positions, the vehicle restraint 226 (i.e., the control circuitry 512) can determine when the vehicle restraint 226 is reconfigured from the trailer clamping position to the stored position. In other implementations, the vehicle restraint 226 can include one or more sensors that detect arrival of one or more components at the stored position. For example, a contact sensor can detect arrival of the carriage 506 and/or the actuator 508 at the stored position (FIG. 9) and communicate detected arrival to the control circuitry 512 which can then affect one or more powered elements (e.g., motors) to terminate further movement of the carriage 506 and/or actuator 508.

The reconfiguration process is repeated each time a new trailer arrives at the loading dock. In some instances, the loading dock door may not be opened until the vehicle restraint 226 confirms positive engagement with the trailer bar 402. In other instances, other equipment at the loading dock (e.g., dock levelers, dock seals, etc.) may not be operable until the vehicle restraint 226 confirms positive engagement with the trailer bar 402. Once the vehicle restraint 226 detects positive engagement, a signal can be communicated to a controller that affects a state of the loading dock equipment. The signal notifies the controller of positive engagement with the trailer bar 402, after which the controller can affect state changes of the loading dock equipment.

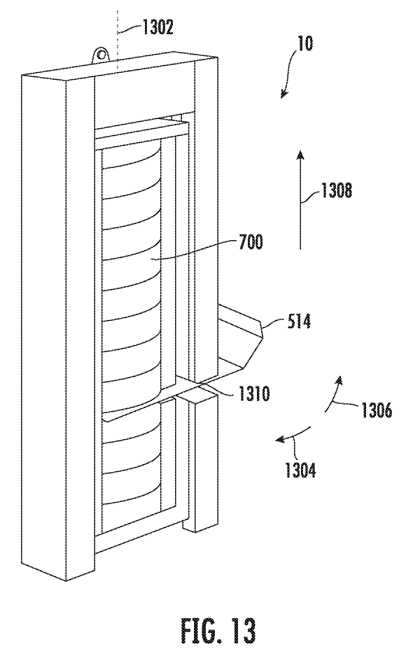

FIG. 13 illustrates the vehicle restraint 226 with a trailer hook 514 that is further displaceable in another direction as the vehicle restraint 226 is reconfigured between the stored and trailer clamping positions. In particular, FIG. 13 illustrates the trailer hook 514 in a stored position rotationally offset from the trailer clamping position about an axis 1302 defined by the screw 700. The trailer hook 514 rotates about the axis 1302 in a first direction 1304 when reconfiguring from the stored position to the trailer clamping position. Conversely, the trailer hook 514 rotates about the axis 1302 in a second direction 1304 when reconfiguring from the trailer clamping position to the stored position. In some instances, reconfiguring the trailer hook 514 in at least one of the first or second directions 1304 or 1306 can be performed by rotation of the screw 700. For example, with the trailer hook 514 in the stored position, initial rotation of the screw 700 can cause the trailer hook to rotate in the first direction 1304, away from the stored position and towards alignment with a ready position (as depicted, e.g., in FIG. 3). The trailer hook 514 can rotate in the first direction 1304 until reaching the ready position, indicated by a stopping feature, such as a portion of the body 320. Further rotation of the screw 700 causes the trailer hook 514 to move upward 1308 to compress against the trailer bar such as depicted in FIG. 12.

In some implementations, the vehicle restraint 226 can define a guide component, such as a ramped surface 1310, that guides the trailer hook 514 from the stored position to the ready position when the screw 700 rotates in the first direction 1304 and from the ready position to the stored position when the screw 700 rotates in the second direction 1306.

Vehicle restraints described herein operate as low-profile trailer retainment structures that provide ease of use and secure engagement with trailers to mitigate dangers caused by trailer movement, e.g., during loading and unloading. The vehicle restraints described herein may be controlled locally or remotely. The vehicle restraints can receive control signals from other controllers, computers, and systems located at the facility, a remote server, a user device, or the like. In some instances, monitoring for contact of the trailer bar by the trailer hook, compression applied to the trailer bar by the trailer hook, successful engagement (e.g., by a local camera capturing images of the trailer hook), or the like can allow facilities to reduce the risk of danger while allowing for remote inspection and validation of trailer restraint. The vehicle restraint can be tied to validation software that prevents additional operations (e.g., loading dock door opening) until successful engagement is validated. In some instances, the vehicle restraint can even facilitate trailer engagement at dark (i.e., autonomous) warehouses to prevent damage to facility equipment during non-human loading and unloading.

Further aspects of the invention are provided by one or more of the following embodiments:

Embodiment 1. A trailer restraint configured to retain a trailer at a relatively fixed location with respect to a facility, the trailer restraint comprising: a body configured to be anchored to a structure at the facility; a linear actuator rotatably coupled to the body about a pivot point and reconfigurable between a stored position and a trailer engagement position; and a trailer hook translatably driven by the linear actuator between a first position and a second position, wherein the linear actuator is rotatable about the pivot point when the trailer hook is in the first position, and wherein the trailer hook is configured to apply a restraining force to a trailer bar when the trailer hook is in the second position.

Embodiment 2. The trailer restraint of any one or more embodiments, wherein the body comprises a guide assembly, and wherein the guide assembly comprises: a guide; a carriage defining the pivot point between the body and the linear actuator; and an actuator configured to move the carriage along the guide.

Embodiment 3. The trailer restraint of any one or more embodiments, further comprising control circuitry communicatively coupled to the linear actuator and the actuator, wherein the control circuitry transmits control signals to at least one of the linear actuator or actuator to control a relative position thereof.

Embodiment 4. The trailer restraint of any one or more embodiments, wherein the linear actuator comprises: a frame defining the pivot point between the body and the linear actuator; and a screw rotatably coupled to the frame and driven to rotate by a motor, wherein the trailer hook is operably coupled to the screw and configured to move relative to the frame in response to rotation of the screw.

Embodiment 5. The trailer restraint of any one or more embodiments, wherein a rotational axis of the screw is oriented orthogonal to a pivot axis defined by the pivot point.

Embodiment 6. The trailer restraint of any one or more embodiments. wherein the frame defines an opening exposing an internal volume defined by the frame, wherein the trailer hook comprises a base and an arm, wherein the base is disposed in the internal volume of the frame, and wherein the arm extends through the opening.

Embodiment 7. The trailer restraint of any one or more embodiments, wherein the motor is fixedly coupled to the frame and disposed adjacent to a longitudinal end of the screw.

Embodiment 8. The trailer restraint of any one or more embodiments, wherein the trailer hook is rotatably driven about a rotational axis defined by the linear actuator between a stored position and an engagement position.

Embodiment 9. A method of restraining a trailer at a facility, the method comprising: reconfiguring a linear actuator of a trailer restraint from a stored position to a trailer engagement position by rotating the linear actuator about a pivot point in an outward direction; with the linear actuator in the engagement position or rotating toward the engagement position, actuating the linear actuator to translate a trailer hook of the trailer restraint in a first direction to apply a compressive force to a trailer bar; and terminating actuation of the linear actuator upon reaching a prescribed condition.

Embodiment 10. The method of any one or more embodiments, wherein reconfiguring the linear actuator from the stored position to the engagement position is performed by an actuator, and wherein actuating the linear actuator to move the trailer hook is performed by a motor separate from the actuator.

Embodiment 11. The method of any one or more embodiments, further comprising releasing the trailer from the trailer restraint, wherein releasing the trailer comprises: actuating the linear actuator to translate the trailer hook in a second direction opposite the first direction; and reconfiguring the linear actuator from the engagement position to the stored position by rotating the linear actuator in an inward direction.

Embodiment 12. The method of any one or more embodiments, wherein the trailer restraint comprises control circuitry in communication with the linear actuator, and wherein the control circuitry actuates the linear actuator to move in the first direction and terminates actuation upon reaching the prescribed condition.

Embodiment 13. The method of any one or more embodiments, wherein reconfiguring the linear actuator from the stored position to the trailer engagement position further comprises translating the linear actuator in a vertical direction, and wherein translation of the linear actuator in the vertical direction is constrained by a guide.

Embodiment 14. The method of any one or more embodiments, wherein actuating the linear actuator to move the trailer hook causes the trailer bar to become compressed between the trailer hook and a guide movably supporting the linear actuator.

Embodiment 15. A trailer restraint configured to retain a trailer at a relatively fixed location with respect to a facility, the trailer restraint comprising a trailer hook coupled to a linear actuator, the trailer hook movable between a stored position and a trailer clamping position whereby the trailer hook applies compressive force to a trailer bar, and wherein movement from the stored position to the trailer clamping position comprises rotation of the linear actuator about a pivot axis and translation of the trailer hook towards the pivot axis.

Embodiment 16. The trailer restraint of any one or more embodiments, further comprising a body configured to be anchored to a structure at the facility, wherein the linear actuator is rotatably coupled to the body, wherein the body comprises a guide assembly, and wherein the guide assembly comprises: a guide; a carriage defining the pivot point between the body and the linear actuator; and an actuator configured to move the carriage along the guide.

Embodiment 17. The trailer restraint of any one or more embodiments, wherein the linear actuator comprises: a frame defining the pivot point between the body and the linear actuator; and a screw rotatably coupled to the frame and driven to rotate by a motor, wherein the trailer hook is operably coupled to the screw and configured to move relative to the frame in response to rotation of the screw.

Embodiment 18. The trailer restraint of any one or more embodiments, wherein movement from the stored position to the trailer clamping position further comprises translatably driving the linear actuator.

Embodiment 19. The trailer restraint of any one or more embodiments, further comprising a locking implement that locks the trailer hook in the trailer clamping position.

Embodiment 20. The trailer restraint of any one or more embodiments, further comprising control circuitry configured to transmit control signals to control actuation of the linear actuator.

Embodiment 21. A trailer restraint configured to retain a trailer at a relatively fixed location with respect to a facility, the trailer restraint comprising:

a body configured to be anchored to a structure at the facility;

a linear actuator rotatably coupled to the body about a pivot point and reconfigurable between a stored position and a trailer engagement position; and

a trailer hook translatably driven by the linear actuator between a first position and a second position, wherein the linear actuator is rotatable about the pivot point when the trailer hook is in the first position, and wherein the trailer hook is configured to apply a restraining force to a trailer bar when the trailer hook is in the second position.

Embodiment 22. The trailer restraint of embodiment 21, wherein the body comprises a guide assembly, and wherein the guide assembly comprises:

a guide;

a carriage defining the pivot point between the body and the linear actuator; and

an actuator configured to move the carriage along the guide.

Embodiment 23. The trailer restraint of embodiment 22, further comprising control circuitry communicatively coupled to the linear actuator and the actuator, wherein the control circuitry transmits control signals to at least one of the linear actuator or actuator to control a relative position thereof.

Embodiment 24. The trailer restraint of embodiment 21, wherein the linear actuator comprises:

a frame defining the pivot point between the body and the linear actuator; and

a screw rotatably coupled to the frame and driven to rotate by a motor,

wherein the trailer hook is operably coupled to the screw and configured to move relative to the frame in response to rotation of the screw.

Embodiment 25. The trailer restraint of embodiment 24, wherein a rotational axis of the screw is oriented orthogonal to a pivot axis defined by the pivot point.

Embodiment 26. The trailer restraint of embodiment 24, wherein the frame defines an opening exposing an internal volume defined by the frame, wherein the trailer hook comprises a base and an arm, wherein the base is disposed in the internal volume of the frame, and wherein the arm extends through the opening.

Embodiment 27. The trailer restraint of embodiment 24, wherein the motor is fixedly coupled to the frame and disposed adjacent to a longitudinal end of the screw.

Embodiment 28. The trailer restraint of embodiment 21, wherein the trailer hook is rotatably driven about a rotational axis defined by the linear actuator between a stored position and an engagement position.

Embodiment 29. A method of restraining a trailer at a facility, the method comprising:

reconfiguring a linear actuator of a trailer restraint from a stored position to a trailer engagement position by rotating the linear actuator about a pivot point in an outward direction;

with the linear actuator in the engagement position or rotating toward the engagement position, actuating the linear actuator to translate a trailer hook of the trailer restraint in a first direction to apply a compressive force to a trailer bar; and

terminating actuation of the linear actuator upon reaching a prescribed condition.

Embodiment 30. The method of embodiment 29, wherein reconfiguring the linear actuator from the stored position to the engagement position is performed by an actuator, and wherein actuating the linear actuator to move the trailer hook is performed by a motor separate from the actuator.

Embodiment 31. The method of embodiment 29, further comprising releasing the trailer from the trailer restraint, wherein releasing the trailer comprises:

actuating the linear actuator to translate the trailer hook in a second direction opposite the first direction; and

reconfiguring the linear actuator from the engagement position to the stored position by rotating the linear actuator in an inward direction.

Embodiment 32. The method of embodiment 29, wherein the trailer restraint comprises control circuitry in communication with the linear actuator, and wherein the control circuitry actuates the linear actuator to move in the first direction and terminates actuation upon reaching the prescribed condition.

Embodiment 33. The method of embodiment 29, wherein reconfiguring the linear actuator from the stored position to the trailer engagement position further comprises translating the linear actuator in a vertical direction, and wherein translation of the linear actuator in the vertical direction is constrained by a guide.

Embodiment 34. The method of embodiment 29, wherein actuating the linear actuator to move the trailer hook causes the trailer bar to become compressed between the trailer hook and a guide movably supporting the linear actuator.

Embodiment 35. A trailer restraint configured to retain a trailer at a relatively fixed location with respect to a facility, the trailer restraint comprising a trailer hook coupled to a linear actuator, the trailer hook movable between a stored position and a trailer clamping position whereby the trailer hook applies compressive force to a trailer bar, and wherein movement from the stored position to the trailer clamping position comprises rotation of the linear actuator about a pivot axis and translation of the trailer hook towards the pivot axis.

Embodiment 36. The trailer restraint of embodiment 35, further comprising a body configured to be anchored to a structure at the facility, wherein the linear actuator is rotatably coupled to the body, wherein the body comprises a guide assembly, and wherein the guide assembly comprises:

a guide;

a carriage defining the pivot point between the body and the linear actuator; and

an actuator configured to move the carriage along the guide.

Embodiment 37. The trailer restraint of embodiment 36, wherein the linear actuator comprises:

a frame defining the pivot point between the body and the linear actuator; and

a screw rotatably coupled to the frame and driven to rotate by a motor,

wherein the trailer hook is operably coupled to the screw and configured to move relative to the frame in response to rotation of the screw.

Embodiment 38. The trailer restraint of embodiment 35, wherein movement from the stored position to the trailer clamping position further comprises translatably driving the linear actuator.

Embodiment 39. The trailer restraint of embodiment 35, further comprising a locking implement that locks the trailer hook in the trailer clamping position.

Embodiment 40. The trailer restraint of embodiment 35, further comprising control circuitry configured to transmit control signals to control actuation of the linear actuator.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A trailer restraint configured to retain a trailer at a relatively fixed location with respect to a facility, the trailer restraint comprising:
a body configured to be anchored to a structure at the facility;
a linear actuator rotatably coupled to the body about a pivot point and reconfigurable between a stored position and a trailer engagement position; and
a trailer hook configured to be translatably driven by the linear actuator between a first position and a second position, wherein the linear actuator is rotatable about the pivot point when the trailer hook is in the first position, and wherein the trailer hook is configured to apply a restraining force to a trailer bar when the trailer hook is in the second position.

2. The trailer restraint of claim 1, wherein the body comprises a guide assembly, and wherein the guide assembly comprises:
a guide;
a carriage defining the pivot point between the body and the linear actuator; and
an actuator configured to move the carriage along the guide.

3. The trailer restraint of claim 2, further comprising control circuitry communicatively coupled to the linear actuator and the actuator, wherein the control circuitry transmits control signals to at least one of the linear actuator or actuator to control a relative position thereof.

4. The trailer restraint of claim 1, wherein the linear actuator comprises:
a frame defining the pivot point between the body and the linear actuator; and
a screw rotatably coupled to the frame and driven to rotate by a motor,
wherein the trailer hook is operably coupled to the screw and configured to move relative to the frame in response to rotation of the screw.

5. The trailer restraint of claim 4, wherein a rotational axis of the screw is oriented orthogonal to a pivot axis defined by the pivot point.

6. The trailer restraint of claim 4, wherein the frame defines an opening exposing an internal volume defined by the frame, wherein the trailer hook comprises a base and an arm, wherein the base is disposed in the internal volume of the frame, and wherein the arm extends through the opening.

7. The trailer restraint of claim 4, wherein the motor is fixedly coupled to the frame and disposed adjacent to a longitudinal end of the screw.

8. The trailer restraint of claim 1, wherein the trailer hook is rotatably driven about a rotational axis defined by the linear actuator between a stored position and an engagement position.

9. A method of restraining a trailer at a facility, the method comprising:
reconfiguring a linear actuator of a trailer restraint from a stored position to a trailer engagement position by rotating the linear actuator about a pivot point in an outward direction;
with the linear actuator in the engagement position or rotating toward the engagement position, actuating the linear actuator to translate a trailer hook of the trailer restraint in a first direction to apply a compressive force to a trailer bar; and
terminating actuation of the linear actuator upon reaching a prescribed condition.

10. The method of claim 9, wherein reconfiguring the linear actuator from the stored position to the engagement position is performed by an actuator, and wherein actuating the linear actuator to move the trailer hook is performed by a motor separate from the actuator.

11. The method of claim 9, further comprising releasing the trailer from the trailer restraint, wherein releasing the trailer comprises:
actuating the linear actuator to translate the trailer hook in a second direction opposite the first direction; and
reconfiguring the linear actuator from the engagement position to the stored position by rotating the linear actuator in an inward direction.

12. The method of claim 9, wherein the trailer restraint comprises control circuitry in communication with the linear actuator, and wherein the control circuitry actuates the linear actuator to move in the first direction and terminates actuation upon reaching the prescribed condition.

13. The method of claim 9, wherein reconfiguring the linear actuator from the stored position to the trailer engagement position further comprises translating the linear actuator in a vertical direction, and wherein translation of the linear actuator in the vertical direction is constrained by a guide.

14. The method of claim 9, wherein actuating the linear actuator to move the trailer hook causes the trailer bar to become compressed between the trailer hook and a guide movably supporting the linear actuator.

15. A trailer restraint configured to retain a trailer at a relatively fixed location with respect to a facility, the trailer restraint comprising a trailer hook coupled to a linear actuator, the trailer hook movable between a stored position and a trailer clamping position whereby the trailer hook applies compressive force to a trailer bar, and wherein movement from the stored position to the trailer clamping position comprises rotation of the linear actuator about a pivot axis and translation of the trailer hook towards the pivot axis.

16. The trailer restraint of claim 15, further comprising a body configured to be anchored to a structure at the facility, wherein the linear actuator is rotatably coupled to the body, wherein the body comprises a guide assembly, and wherein the guide assembly comprises:
a guide;
a carriage defining the pivot axis between the body and the linear actuator; and
an actuator configured to move the carriage along the guide.

17. The trailer restraint of claim 16, wherein the linear actuator comprises:
a frame defining the pivot axis between the body and the linear actuator; and
a screw rotatably coupled to the frame and driven to rotate by a motor,
wherein the trailer hook is operably coupled to the screw and configured to move relative to the frame in response to rotation of the screw.

18. The trailer restraint of claim 15, wherein movement from the stored position to the trailer clamping position further comprises translatably driving the linear actuator.

19. The trailer restraint of claim 15, further comprising a locking implement that locks the trailer hook in the trailer clamping position.

20. The trailer restraint of claim 15, further comprising control circuitry configured to transmit control signals to control actuation of the linear actuator.
